(19) United States
(12) Patent Application Publication
(10) Pub. No.: US 2016/0000255 A1
(43) Pub. Date: Jan. 7, 2016

(54) BASKET FOR DRINKS-PREPARING MACHINE

(71) Applicant: ETHICAL COFFEE COMPANY SA, Fribourg (CH)

(72) Inventor: Alain MARILLER, Les Monts-de-Corsier (CH)

(21) Appl. No.: 14/767,558

(22) PCT Filed: Jan. 29, 2014
(86) PCT No.: PCT/IB2014/058641

§ 371 Date: Aug. 12, 2015

(30) Foreign Application Priority Data
Feb. 13, 2013 (IB) PCT/IB2013/051175

(51) Int. Cl. A47J 31/06; A23F 5/26; A47J 31/36

(52) U.S. Cl. CPC A47J 31/0678; A47J 31/3623; A23F 5/26

(57) ABSTRACT

The invention relates to a basket for a machine used to prepare a drink, e.g. coffee, comprised within a container, said basket having an edge with at least one groove, said groove being closed by at least one bottom preventing a direct connection between the inside and the outside of the basket.

### REFERENCE TO A PRIOR APPLICATION

The present application claims priority from the prior application No. PCT/IB2013/051175 filed on 13 Feb. 2013 in the name of the same Applicant as the present application, the content of that prior application being incorporated by reference in its entirety in the present application.

### FIELD OF THE INVENTION

The invention relates to methods for preparing drinks, for example, coffee, by introducing water into an element which contains a concentrated measure of product, for example, coffee grounds, and by means of extraction of the mixture obtained in this manner, and more particularly the devices used for this purpose.

### PRIOR ART

There are known various types of elements which contain a concentrated measure through which water is introduced, mixed with the concentrated measure, then extracted from the element.

The element is, for example, in the form of a capsule or another equivalent receptacle which is introduced into a basket and which is, for example, called a capsule type basket.

The introduction of water into the capsule type element is carried out by piercing at least one wall of the element. The extraction can be carried out by piercing, tearing or bursting a wall of the element or by another equivalent process.

The basket in particular enables the element (for example, the capsule) containing the measure of product to be retained during the process of extraction and preparation of the drink.

The combination basket/capsule (or any other element which contains the measure of product) has to be impermeable during the extraction and to allow them to be separated after the extraction process has been completed.

The publications EP 1 654 966 and WO 2009/090201 describe a capsule basket in a coffee machine, the basket comprising a rim which is serrated, with radial apertures or grooves which place the outer side of the basket in relation to the inner side thereof in order to allow the passage of air between the outer side and the inner side of the basket and to facilitate the extraction of the capsule from the basket, after it has been used.

A major disadvantage of these grooves is precisely the fact that they place the outer side and the inner side of the basket in a direct relationship, which impairs the impermeability during the extraction process.

This serrated or toothed wall is nonetheless advantageous for forming a joint on a rim of the capsule when the drink is extracted.

General Statement of Invention

One of the objects of the invention is to provide an improved device for the preparation of a drink.

In particular, an object of the present invention is to provide an extraction device which both retains optimum impermeability during the extraction process and at the same time allows easy separation of the basket and the element which contains, for example, a capsule, after the extraction process has been completed.

This objective is achieved in particular by the means as defined in the claims.

According to one embodiment, the basket comprises a rim with at least one groove, the groove being closed by at least one base which prevents a direct link between the inner side and the outer side of the basket.

The basket may comprise a plurality of grooves.

The grooves may or may not extend perpendicularly to the axis of the basket.

The grooves may have the same length or different lengths.

The grooves may have the same depth or different depths.

The grooves may have the same shape or different shapes.

The groove(s) may or may not be formed directly in the basket.

The groove(s) may be formed in at least one component which is fixed to the basket or in one or more component(s) and in the basket or be formed by components fixed to the basket. The component(s) may be fitted to the basket or fixed with force thereto. Any other equivalent fixing means (adhesive bonding, screwing, etcetera) may be envisaged in the context of the present invention. In the same manner, the base of the groove may or may not be formed by one added component (fixed, fitted, etcetera). It may be formed in the basket.

The component or the components may be of the same material as the basket or of another material.

The basket may be in combination with a capsule, for example, a coffee capsule. The capsule may comprise means which form a joint, such as a bead or a peak of material.

The invention also relates to a device which is for extracting a drink and which comprises a basket as defined in the present application with or without a capsule.

### DETAILED STATEMENT OF INVENTION

The invention is described in greater detail below with reference to embodiments illustrated by the Figures.

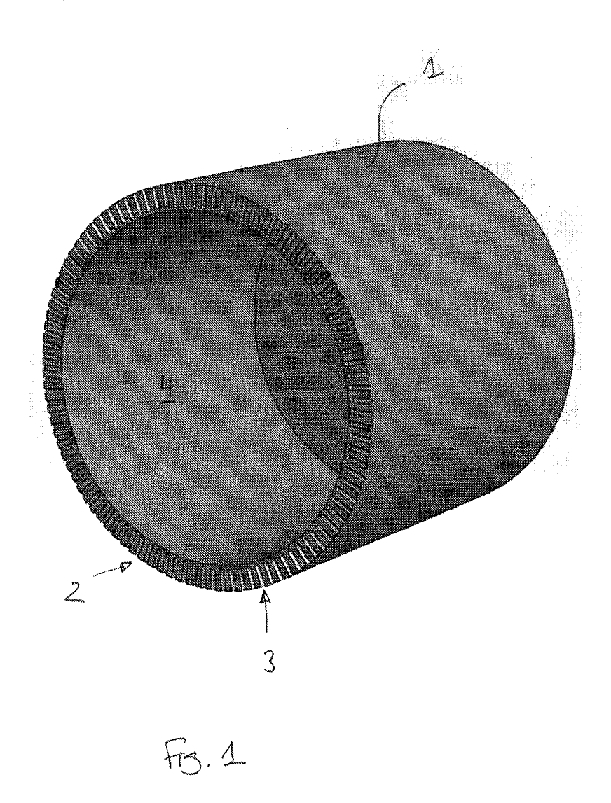

FIG. 1 is a perspective view of a basket 1, for example, a capsule basket.

The basket 1 comprises a rim 2 which is provided, as in the publications mentioned above, with grooves 3 which extend perpendicularly to the axis of the basket.

However, and in contrast to what has been taught in these prior publications, the grooves 3 according to the present invention do not extend over the whole of the rim, but instead terminate before reaching the inner wall 4 of the basket 3 via a base 5 which creates grooves 3 which are in the form of a “cul de sac” and which are closed at one of the ends thereof.

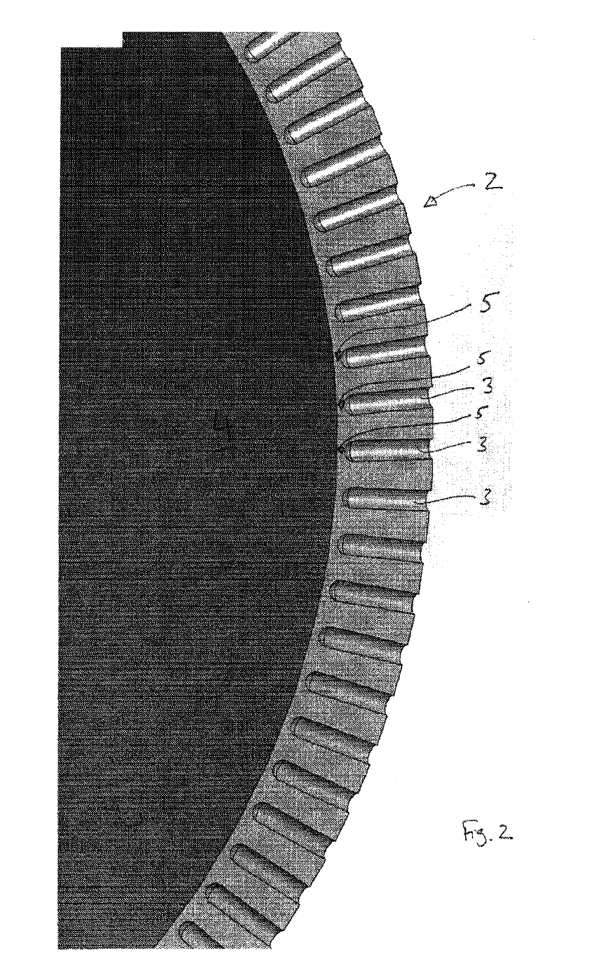

This construction is illustrated in detail in FIGS. 2 and 3 which are front and sectioned views of the rim 2 of the basket 1, respectively.

In this manner, the joint created between the rim 2 of the basket 1 and the capsule (which is not illustrated in this Figure but which corresponds to the principles set out in the publications cited above and can be readily envisaged by a person skilled in the art) during the extraction, which brings about a pressurization of the inner side of the basket, is not weakened by continuous grooves as taught in the prior art.

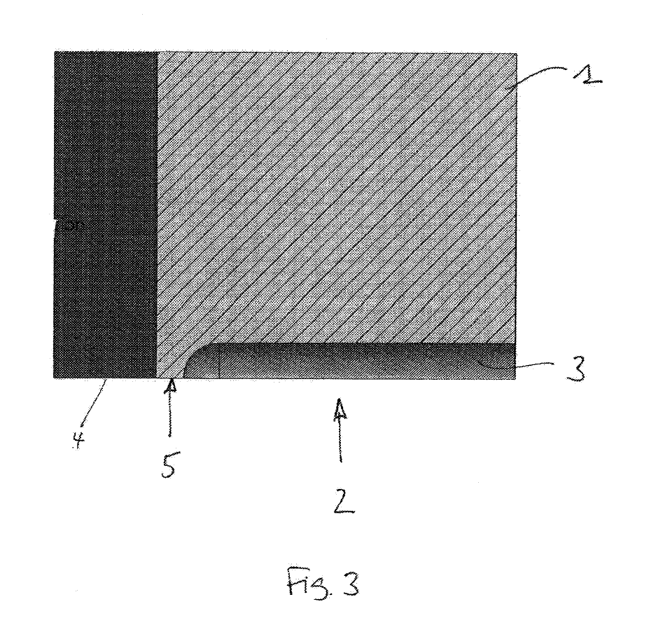

FIGS. 4 to 6 illustrate basket configurations according to the invention with different capsules which may or may not comprise a joint, the left side of the Figures being the inner side of the basket (where the capsule is located).

In FIG. 4, the basket 1 according to the invention is associated with a capsule 10 which comprises a bead 11 of material on the rim 10′ thereof which enables a joint in the base 5 of the groove 3 by the base 5 being pressed in the bead 11.

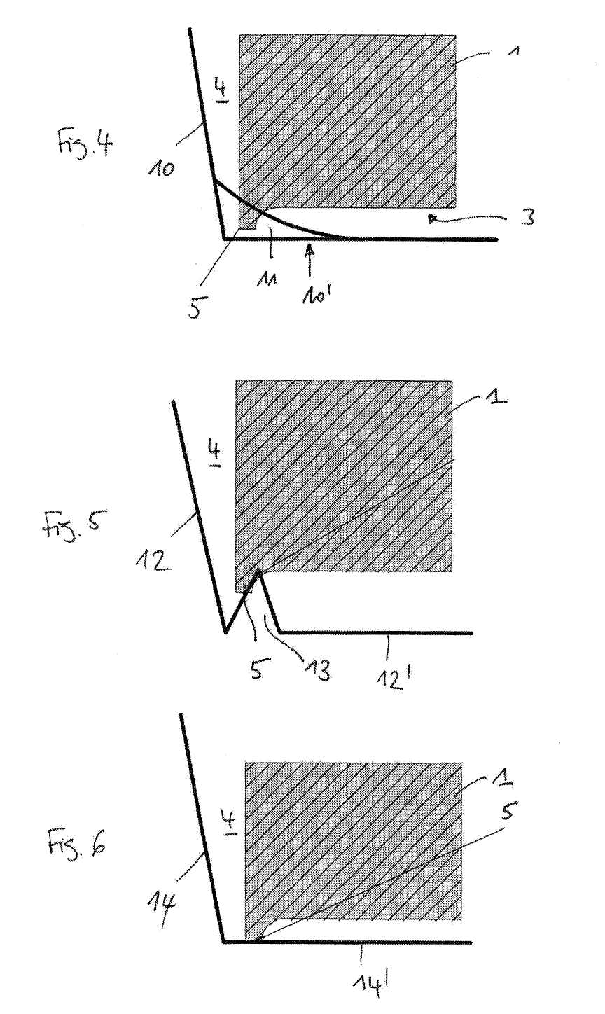

In FIG. 5, the basket 1 according to the invention is associated with a capsule 12 which comprises a peak 13 of material on the edge 12′ thereof which allows a joint in the base 5 of the groove 3 by the base being pressed in the peak 13. This peak 13 may have the shape illustrated or a different equivalent shape, for example, a square shape, etcetera.

In FIG. 6, the basket 1 according to the invention is associated with a capsule 14 which does not comprise a specific joint element on the rim 14′ thereof. Nonetheless, in such a configuration, a good basket/capsule joint is obtained by the specific configuration of the groove 3 according to the invention with the base 5 thereof by applying the principles set out above.

The invention is not limited to the embodiments described in the present application and variations are possible in the context of the protection claimed.

It is possible to form any number of grooves 3 in the rim 2 of the basket and the Figures serve only to illustrate the principle. It is also possible to make provision for more than one base 5 to be positioned per groove 3.

The length of the grooves (and the thickness of the base) may be the same in each groove 3 or different. It is possible, for example, to alternate thick and thin bases 5 (therefore, short or long grooves) or to vary them in accordance with another rule.

The grooves 2 may be strictly perpendicular to the axis of the basket 1 or may have an inclination: that is to say that they will be deeper at one side (for example, at the side of the base 5) than the other. The reverse is also possible.

In a similar manner, the grooves 3 may or may not have a constant width (as illustrated in FIG. 2, for example). In this manner, they may be wider (or less wide) at the side of the base or at the other side.

The grooves may or may not be perpendicular to the axis of the basket. Furthermore, the grooves may have a shape which extends along a rectilinear axis, or along a curved axis.

Their arrangement may or may not be parallel, for example, in the form of chevrons, etcetera.

It is, of course, possible to combine different types of grooves 3 as described above on the same basket 1 and to alternate and/or combine all the variants described.

Preferably, the grooves 3 are formed by means of any appropriate method directly in the rim of the basket.

Alternatively, it is also possible to provide an appropriate component (for example, a rim which can be disassembled) which carries these grooves 3 and which is mounted on a basket 3 whether or not the basket has grooves. It is possible, for example, to provide ideal “groove/capsule” pairs in which the grooves (number, shape, etcetera) are optimized for a given type of capsule (or by extension for any receptacle used).

In another alternative, using a removable rim enables it to be changed in accordance with wear without changing the basket 1.

The use of a removable rim also allows appropriate materials to be selected which would not be the same as that of the basket 1. These materials may be metal or a synthetic material, for example, another appropriate material.

The embodiments described and the features thereof may be freely mutually combined in accordance with circumstances.

1. A basket for a machine which is used in the preparation of a drink, for example, coffee, in a receptacle, the basket comprising a rim with at least one groove, the groove being closed by at least one base which prevents a direct link between the inner side and the outer side of the basket.

2. The basket as claimed in claim 1, comprising a plurality of grooves.

3. The basket as claimed in claim 1, wherein the groove(s) may or may not extend perpendicularly to the axis of the basket.

4. The basket as claimed in claim 1, wherein the grooves have the same length or different lengths.

5. The basket as claimed in claim 1, wherein the grooves have the same depth or different depths.

6. The basket as claimed in claim 1, wherein the grooves have the same shape or different shapes.

7. The basket as claimed in claim 1, wherein the groove(s) and/or the base is/are formed in the basket.

8. The basket as claimed in claim 1, wherein the groove(s) and/or the base is/are formed in at least one component which is fixed to the basket or in one or more component(s) and/or in the basket.

9. The basket as claimed in claim 8, wherein the component or the components is/are of the same material as the basket or of another material.

10. The basket as claimed in claim 1 in combination with a capsule containing a product which is intended to form a drink, for example, coffee.

11. The basket as claimed in claim 1, wherein the capsule comprises means which form a joint and which cooperate with the groove(s) of the basket.

12. The basket as claimed in claim 1, wherein the means which form a joint comprise a bead or a peak.

13. A device which is for extracting a drink and which comprises a basket as defined in claim 1.

14. The device for extracting a drink in combination with a basket as defined in claim 1.

15. A method for extracting a drink, from an element which contains a concentrated measure of a product, for example, coffee grounds, by means of extraction of the mixture obtained in this manner, the method using a basket as defined in claim 1.
